(19) United States
(12) Patent Application Publication
(10) Pub. No.: US 2004/0082221 A1
(43) Pub. Date: Apr. 29, 2004

(54) Electric connector for fluorescent lamp

(76) Inventor: Chaio-Lan Lu, Hsin-Chu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/277,952

(22) Filed: Oct. 23, 2002

(51) Int. Cl. H01R 33/02

(52) U.S. Cl. 439/607

(57) ABSTRACT

An electric connector for fluorescent lamp formed of a housing, a big compression spring, a small compression spring, a locating plate, two metal conducting plates, two lead wires, a protective cover shell, and a top cover plate. The housing has two gates and two retainers in the gates to hold the front ends of the metal conducting plates in place. Each metal conducting plate has an angled locating portion and two parallel engagement portion for securing the conductors of the respective lead wire without soldering.

### BACKGROUND OF THE INVENTION

1. Field of the Invention

The present invention relates to a fluorescent lamp and, more specifically, to an electric connector for use in a fluorescent lamp to receive the pins of one base of a fluorescent bulb.

2. Description of the Related Art

FIGS. from 1A, 1B, 2A, 2B, and 3 show an electric connector for use in a fluorescent lamp to receive the pins of one base of a fluorescent bulb according to the prior art. According to this design, the electric connector is comprised of a housing 10′, a top cover plate 13′, a locating plate 17′, a big compression spring 18′, a small compression spring 19′, two symmetrical metal conducting plates 20′, and a protective cover shell 60′. The housing 10′ has two front openings 11′, two pairs of vertical locating grooves 12′ respectively disposed inside the openings 11′, and an upright stub tube 16′ at the center of the bottom wall on the inside. The top cover plate 13′ has two front notches 15′ corresponding to the front openings 11′ of the housing 10′, and a truncated circular top opening 14′. The two symmetrical metal conducting plates 20′ each have an elongated base portion 24′, a front mounting portion 25′ downwardly extended from the front end of the elongated base portion 24′ at right angles, a flat rear contact portion 21′, a circular recess 22′ in the flat rear contact portion 21′, and a connecting portion 23′ vertically upwardly extended from the rear end of the elongated base portion 24′ and terminating in the front end of the flat rear contact portion 21′. The big compression spring 18′ and the small compression spring 19′ are respectively and concentrically mounted within and outside the upright stub tube 16′ of the housing 10′. The locating plate 17′ is supported on the big compression spring 18′ and the small compression spring 19′ to hold the rear contact portions 21′ of the metal conducting plates 20′, for enabling the connecting portions 23′ of the metal conducting plates 20′ to be respectively stopped at the vertical front sidewall of the locating plate 17′ and the front mounting portions 25′ of the metal conducting plates 20′ to be respectively positioned in the vertical locating grooves 12′ of the housing 10′. The protective cover shell 60′ is mounted within the housing 10′ to hold the locating plate 17′ and the metal conducting plates 20′ in place, having a downwardly extended center mounting plug rod 61′ inserted into the small compression spring 19′ in the upright stub tube 16′ of the housing 10′. After installation of the protective cover shell 60′ in the housing 10′, the top cover plate 13′ is covered on the top open side of the housing 10′ and fixedly secured thereto, keeping the protective cover shell 60′ received in the truncated circular top opening 14′ of the top cover plate 13′. This structure of electric connector has numerous drawbacks as outlined hereinafter.

1. Because the front mounting portion 25′ of each metal conducting plate 20′ is a planar portion, the conductor C′ of the corresponding lead wire B′ must be fastened to the front mounting portion 25‘with tin solder D’ by a soldering apparatus. This soldering procedure consumes much labor and time and, causes pollutions to the environment.

2. The connection between the metal conducting plates 20′ and the housing 10′ is unstable. Simply by inserting the front mounting portions 25′ of the metal conducting plates 20′ into the vertical locating grooves 12′ of the housing 10′ cannot positively and firmly secure the metal conducting plates 20′ to the housing 10′ in position.

3. The spring power of the springs 18′ and 19′ is insufficient to hold the circular recesses 22′ of the metal conducting plates 20′ in positive contact with the respective tube pins of the fluorescent bulb.

4. Because the rear contact portions 21′ of the metal conducting plates 20′ are not fixedly secured to the locating plate 17′, they tend to be forced out of place.

### SUMMARY OF THE INVENTION

The present invention has been accomplished under the circumstances in view. It is therefore the main object of the present invention to provide an electric connector for fluorescent lamp, which eliminates the aforesaid drawbacks. It is another object of the present invention to provide an electric connector for fluorescent lamp, which positively secures the front ends of the metal conducting plates in place. It is another object of the present invention to provide an electric connector for fluorescent lamp, which enables the lead wires to be quickly installed without soldering. To achieve these and other objects of the present invention, the electric connector for fluorescent lamp is comprised of a housing, a big compression spring, a small compression spring, a locating plate, two metal conducting plates, two lead wires, a protective cover shell, and a top cover plate. The housing has two gates and two retainers in the gates to hold the front ends of the metal conducting plates in place. Each metal conducting plate has an angled locating portion and two parallel engagement portion for securing the conductors of the respective lead wire without soldering. Further each metal conducting plate has an oblique supporting portion connected between the elongated base and vertical connecting portion thereof so that the rear end of the respective metal conducting plate can freely be moved with the locating plate when the big compression spring and the small compression spring compressed or released.

### BRIEF DESCRIPTION OF THE DRAWINGS

FIG. 1A is an elevational view of a housing for an electric connector for fluorescent lamp according to the prior art.

FIG. 1B is an elevational perspective view of a top cover plate for the prior art electric connector for fluorescent lamp.

FIG. 2A is an elevational view of a metal conducting plate for the prior art electric connector for fluorescent lamp.

FIG. 2B is a side view showing the conductor of one lead wire soldered to the mounting portion of the metal conducting plate according to the prior art.

FIG. 3 is an exploded view in perspective of the electric connector for fluorescent lamp according to the prior art.

FIG. 4A is an elevational view of a housing for an electric connector for fluorescent lamp according to the present invention.

FIG. 4B is a sectional view taken along line A-A of FIG. 4A.

FIG. 5A is a perspective of a top cover plate for the electric connector for fluorescent lamp according to the present invention.

FIG. 5B is a front view of the top cover plate shown in FIG. 5A.

FIG. 6A is an elevational view of one metal conducting plate for the electric connector for fluorescent lamp according to the present invention.

FIG. 6B is a sectional view in an enlarged scale of a part of the metal conducting plate shown in FIG. 6A.

FIG. 6C is a schematic drawing showing the conductor of a lead wire fastened to the metal conducting plate according to the present invention.

FIG. 6D is an elevational view of an alternate form of the metal conducting plate for the electric connector for fluorescent lamp according to the present invention.

FIG. 7 is an exploded view in perspective of the electric connector for fluorescent lamp according to the present invention.

FIG. 8 is similar to FIG. 7 but showing the locating plate and the metal conducting plates installed in the housing.

FIG. 9 is an elevational view of the electric connector for fluorescent lamp according to the present invention.

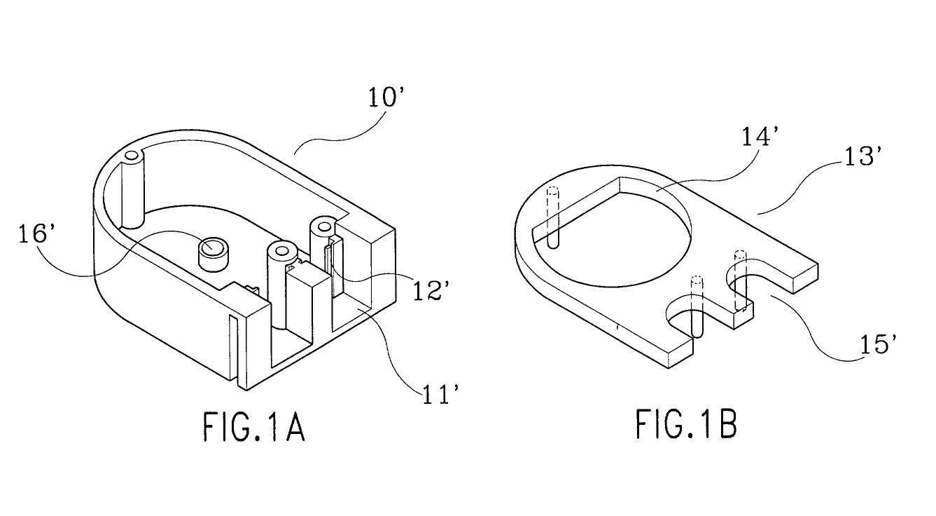

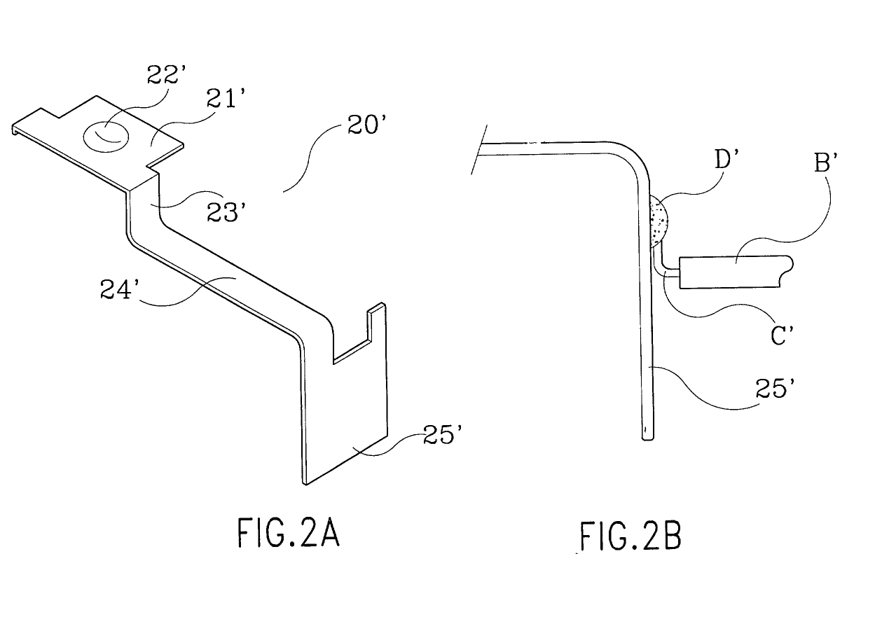

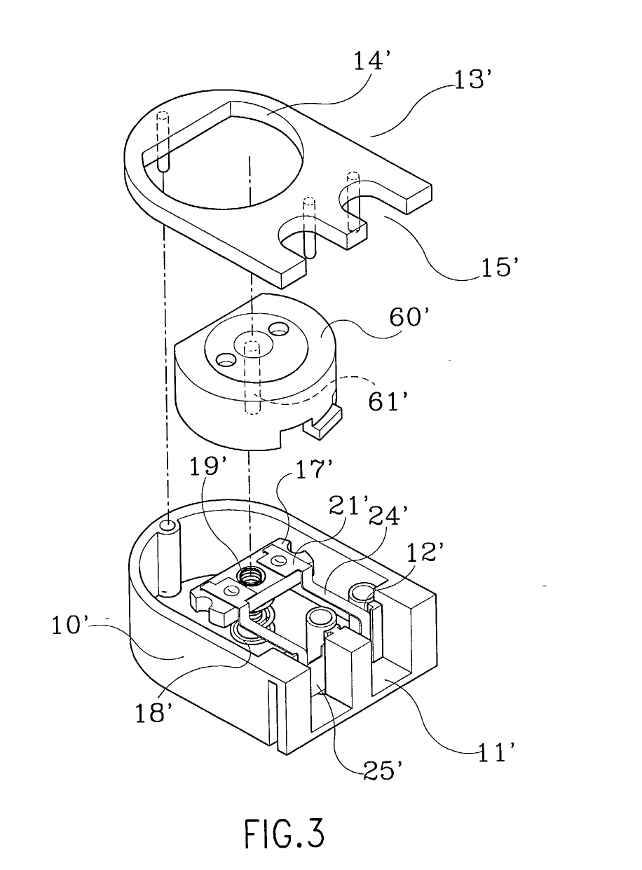

### DETAILED DESCRIPTION OF THE PREFERRED EMBODIMENT

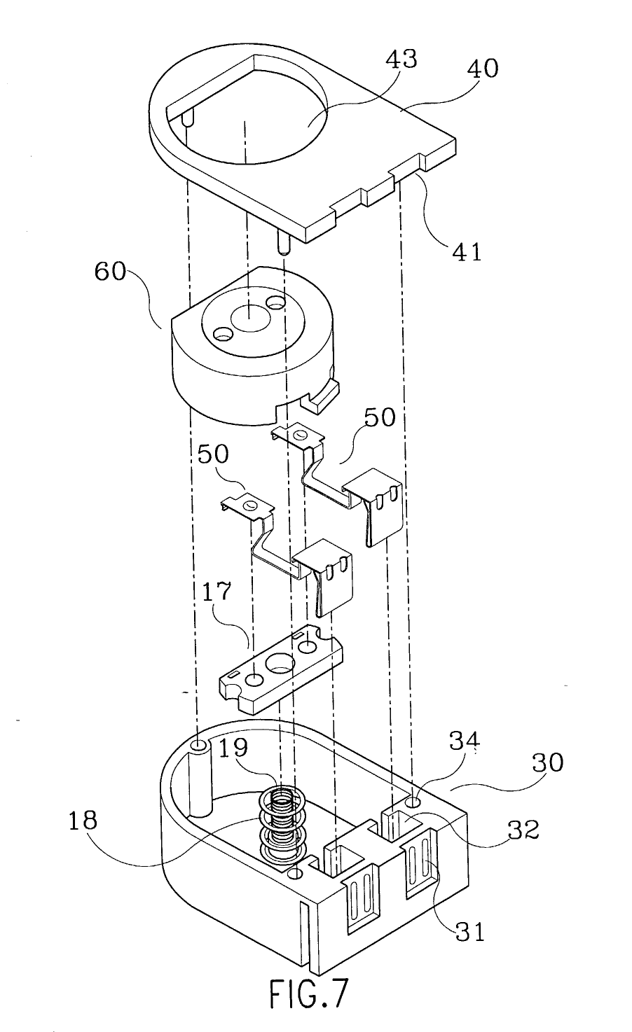

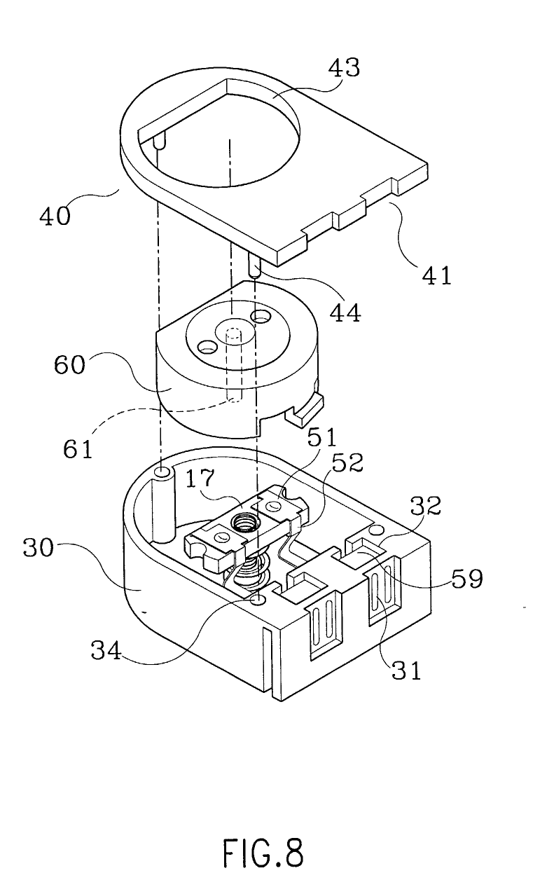

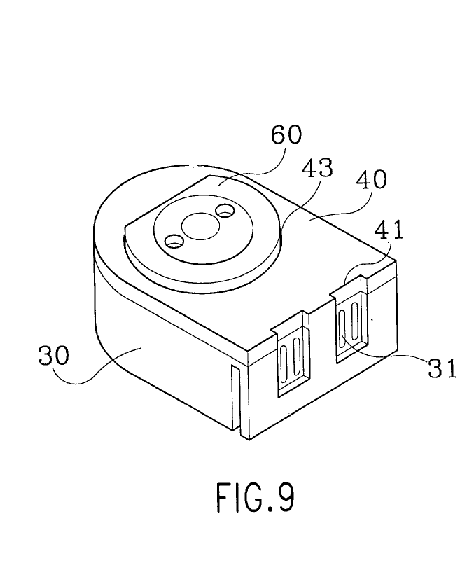

Referring to FIG. 7, an electric connector for fluorescent lamp in accordance with the present invention is shown comprised of an electrically insulating housing 30, an electrically insulating top cover plate 40, an electrically insulating locating plate 17, a big compression spring 18, a small compression spring 19, two symmetrical metal conducting plates 50, and an electrically insulating protective cover shell 60.

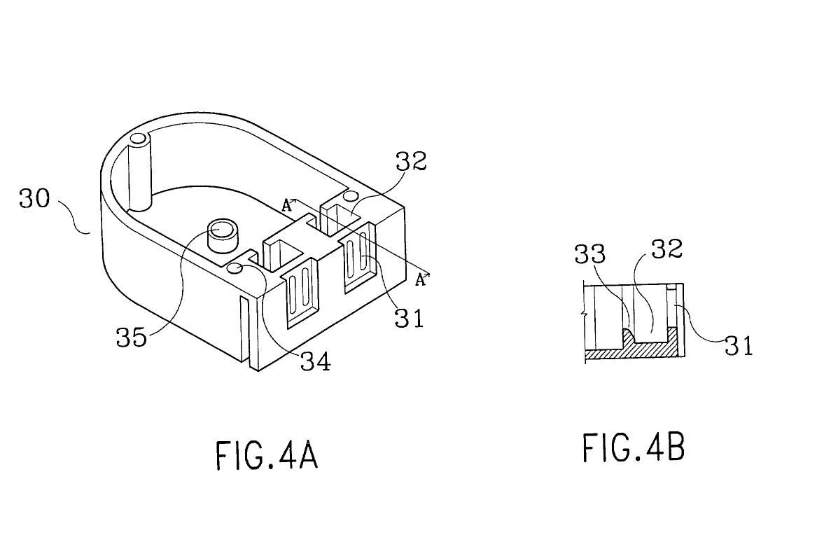

Referring to FIGS. 4A and 4B, the housing 30 is shaped like an oblong box, having two front gates 32, a plurality of top plug holes 34 in the top side of the peripheral wall thereof, and an upright stub tube 35 at the center of the bottom wall on the inside. Each front gate 32 comprises two insertion slots 31 and a retainer 33 behind the insertion slots 31.

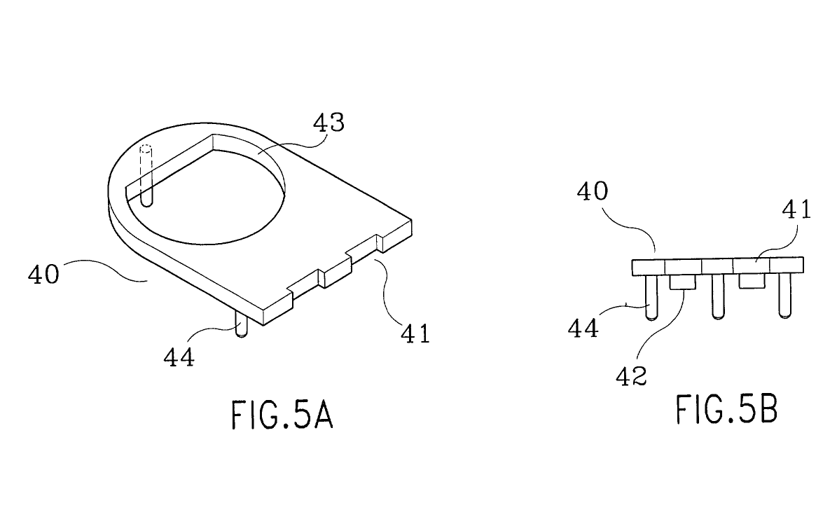

Referring to FIGS. 5A and 5B, the top cover plate 40 has two front notches 41 corresponding to the front gates 32 of the housing 30, two bottom press rods 42 corresponding to the retainers 33 of the front gates 32 of the housing 30, a truncated circular top opening 43, and a plurality of bottom mounting rods 44 corresponding to the top plug holes 34 of the housing 30.

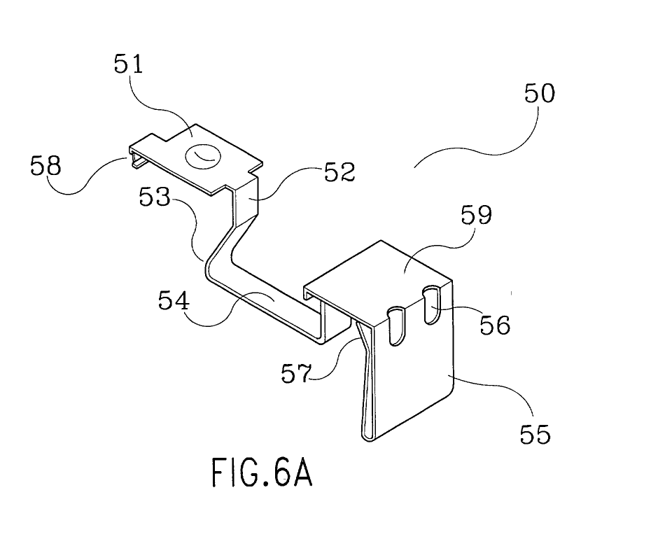

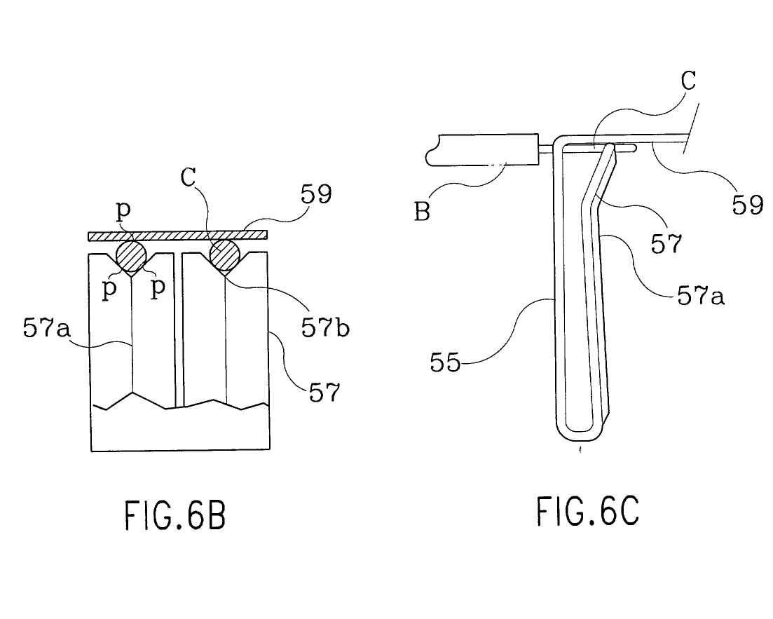

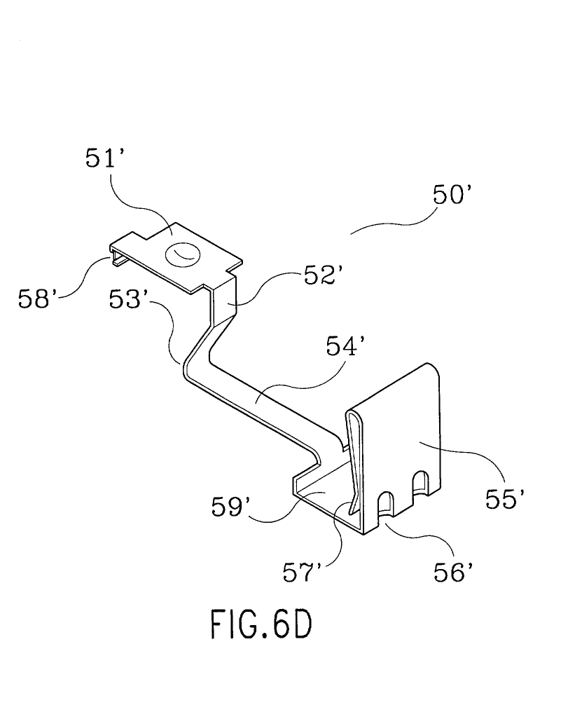

Referring to FIGS. 6A, 6B. and 6C, each metal conducting plate 50 comprises an elongated base portion 54, a flat contact portion 51, a hooked rear end portion 58 protruded from the rear end of the flat contact portion 51, a vertical connecting portion 52 vertically downwardly extended from the front end of the contact portion 51, an oblique supporting portion 53 connected between the bottom end of the vertical connecting portion 52 and the rear end of the elongated base portion 54, an angled locating portion 59 vertically upwardly extended from the front end of the elongated base portion 54 and turned horizontally forwards at the same elevation of the flat contact portion 51, a front stop portion 55 vertically downwardly extended from the front end of the angled locating portion 59 at right angles, two insertion slots 56 cut through the top ends of the front stop portion 55, and two parallel engagement portions 57 extended from the bottom end of the front stop portion 55 and then turned vertically upwards and then obliquely upwards toward the horizontal bottom surface of the angled locating portion 59. The engagement portions 57 each have a substantially V-shaped cross section defining a longitudinally extended and forwardly protruded middle folding line 57a, and a V-shaped top notch 57b. The design of V-shaped cross section reinforces the structural strength of the engagement portions 57.

FIG. 6D shows an alternate form of the metal conducting plate. According to this alternate form, the angled locating portion 59′ extends vertically downwards from the front end of the elongated base portion 54′ and then horizontally forwards; the front stop portion 55′ is vertically upwardly extended from the front end of the angled locating portion 59′ at right angles; and the two parallel engagement portions 57′ are respectively extended from the top end of the front stop portion 55′ and then turned vertically downwards and then obliquely downwards toward the horizontal top surface of the angled locating portion 59′. The other portions of the metal conducting plate 50′ are same as the corresponding portions of the embodiment shown in FIGS. 6A, 6B, and 6C. When this alternate form of metal conducting plate is sued, the structure of the gates of the housing should be relatively matched.

The assembly process of the present invention is outlined hereinafter with reference to FIGS. from 4A through 9. The big compression spring 18 and the small compression spring 19 are respectively and concentrically mounted within and outside the upright stub tube 35 of the housing 30, and then the locating plate 17 is supported on the big compression spring 18 and the small compression spring 19, and then the metal conducting plates 50′ are installed in the housing 30, keeping the hooked rear end portions 58 of the metal conducting plates 50′ respectively hooked on the rear side of the locating plate 17, the contact portions 51 supported on the locating plate 17, the vertical connecting portions 52 stopped at the front side of the locating plate, the elongated base 54 supported on the top surface of the bottom wall of the housing 30, the front stop portions 55 and the fixed ends of the engagement portions 57 respectively inserted into the gates 32 and secured in place by the retainers 33, and the insertion slots 56 respectively aimed at the insertion slots 31 of the gates 32, and then the downwardly extended center mounting plug rod 61 of the protective cover shell 60 is inserted into the small compression spring 19 in the upright stub tube 35 of the housing 30 for enabling the protective cover shell 60 to be secured to the inside of the housing 30 to hold the locating plate 17 and the metal conducting plates 50 in place, and then the bottom mounting rods 44 of the top cover plate 40 are respectively press-fitted into the top plug holes 34 of the housing 30, keeping the bottom press rods-42 pressed on the front ends of the elongated base portions 54 of the metal conducting plates 50 and the protective cover shell 60 received in the truncated circular top opening 43 of the top cover plate 40.

The invention has numerous advantages as outlined hereinafter.

1. The gates 32 of the housing 30 receive the front stop portions 55 of the metal conducting plates 50 positively in place.

2. The retainers 33 of the gates 32 of the housing 30 and the bottom press rods 42 of the top cover plate 40 secure the front ends of the metal contact plates 50 firmly in position.

3. The oblique supporting portions 53 enable the rear ends of the metal conducting plates 50 to be moved freely with the locating plate 17 when the compression springs 18 and 19 compressed or released.

4. The hooked rear end portions 58 of the metal conducting plates 50 are respectively hooked on the rear side of the locating plate 17, keeping the contact portions 51 firmly supported on the locating plate 17 in place.

5. When inserting the conductors C of the lead wires B inserted through the insertion slots 31 of the gates 32 of the housing 30 and the insertion slots 56 of the metal conducting plates 50, the conductors C are respectively engaged into the V-shaped top notches 57b of the engagement portions 57 of the metal conducting plates 50 and held down in position by the horizontal bottom surface of the angled locating portions 59 of the metal conducting plates 50, i.e., each conductor C is maintained in close contact with the respective metal conducting plate 50 at three contact points P. This design eliminates the prior art soldering procedure used to fasten the lead wires to the metal conducting plates.

A prototype of electric connector for fluorescent lamp has been constructed with the features of FIGS. 4˜9. The electric connector for fluorescent lamp functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electric connector for fluorescent lamp of the type comprising:
an electrically insulating housing;
spring means mounted inside said housing;
an electrically insulating locating plate supported on said spring means;
two metal conducting plates respectively mounted inside said housing and supported on said locating plate in parallel;
two lead wires, said lead wires each having at least one conductor respectively fastened to said metal conducting plates;
an electrically insulating protective cover shell mounted inside said housing and covered on said metal conducting plates and said locating plate; and
an electrically insulating top cover plate covered on said housing, said top cover plate having a top opening, which receives said protective cover shell;
wherein
said housing comprises two front gates, said front gates each comprising at least one insertion slot for receiving the at least one conductor of said lead wires and a retainer disposed behind said at least one insertion slot for securing said metal conducting plates to said gates;
said metal conducting plates each comprise an elongated base portion supported on a flat surface portion inside said housing, a flat contact portion supported on said locating plate, a hooked rear end portion protruded from a rear end of said flat contact portion and hooked on a rear side of said locating plate, a vertical connecting portion vertically downwardly extended from a front end of said contact portion, an oblique supporting portion connected between a bottom end of said vertical connecting portion and a rear end of said elongated base portion and suspended inside said housing, an angled locating portion vertically extended from a front end of said elongated base portion and adapted to hold down the at least one conductor of one of said lead wires, a front stop portion vertically extended from a front end of said angled locating portion at right angles, at least one insertion slot cut through said front stop portion and aimed at the at least one insertion slot of one of said gates of said housing, and at least one engagement portion extended from a bottom end of said front stop portion and pressed on the at least one conductor of one of said lead wires against a bottom surface of said angled locating portion.
